(19) United States
(12) Patent Application Publication
(10) Pub. No.: US 2014/0154554 A1
(43) Pub. Date: Jun. 5, 2014

(54) BATTERY MODULE

(71) Applicants: Jong Hwan Kim, Daejeon (KR); Young Suk Kim, Daejeon (KR); Chang Mook Hwang, Daejeon (KR)

(72) Inventors: Jong Hwan Kim, Daejeon (KR); Young Suk Kim, Daejeon (KR); Chang Mook Hwang, Daejeon (KR)

(73) Assignee: SK INNOVATION CO.,LTD., Seoul (KR)

(21) Appl. No.: 14/126,039

(22) PCT Filed: Jul. 30, 2012
(86) PCT No.: PCT/KR2012/006048

§ 371 Date: Dec. 13, 2013

(30) Foreign Application Priority Data
Aug. 24, 2011 (KR) 10-2011-0084254

(51) Int. Cl. H01M 2/36

(52) U.S. Cl. CPC H01M 2/36; H01M 2/361; H01M 2/362
USPC 429/149

(57) ABSTRACT

Provided is a battery module including: an electrode assembly including a plurality of cathode plates, a plurality of anode plates, and a plurality of separators each interposed between the plurality of cathode plates and the plurality of anode plates; a pouch receiving the electrode assembly therein; and an electrode retaining structure received together with the electrode assembly in the pouch and having a space capable of retaining an electrolyte.

### TECHNICAL FIELD

The present invention relates to a battery module, and more particularly, to a battery module capable of having improved performance by inserting an electrolyte retaining structure into a cell of the battery module.

### BACKGROUND ART

A battery may be largely divided into a primary battery and a secondary battery. The primary battery may not be reused after it is used once since it generates electricity using an irreversible reaction. An example of the primary battery includes a dry battery, a mercury battery, a volta battery, and the like. The secondary battery may be reused through charging after it is used since it generates electricity using a reversible reaction unlike the primary battery. An example of the secondary battery includes a lead storage battery, a lithium ion battery, a nickel-cadmium battery, and the like.

Generally, a battery module is configured to include an electrode assembly including a plurality of anode plates, a plurality of cathode plates, and a plurality of separators; and a pouch receiving the electrode assembly therein.

In addition, an electrolyte is injected into the pouch to generate an electrical reaction.

In this case, it is advantageous in view of a lifespan and long term storage of the battery to increase an amount of electrolyte injected into the pouch. However, a limitation value in the amount of electrolyte is determined by a degassing process, and the electrolyte is discharged in the degassing process when the amount of electrolyte increases, such that a contamination problem occurs.

The degassing process indicates a process of removing gas dissolved in the electrolyte.

In addition, when an excessive amount of electrolyte is injected, an injection part is contaminated during a process of manufacturing a battery, such that a problem occurs in reliability of sealing of the pouch.

Further, in the case of decreasing a degree of vacuum in the degassing process in order to solve the problem that the electrolyte is discharged, an excessive amount of electrolyte decreases close adhesion between Ca and An to deteriorate output characteristics and robustness of the battery, such that the battery is deformed.

In order to solve these problems, a technology of forming a shape in which a plurality of tubes are connected to a sidewall of a battery to allow an electrolyte to satisfactorily flow to an outer side of an electrode assembly has been known. However, the shape is complicated and is applicable only to a hard case, such that it is difficult to apply the shape to a pouch type case.

### DISCLOSURE OF INVENTION

### Technical Problem

An object of the present invention is to provide a battery module capable of storing an extra electrolyte therein, preventing an electrolyte from being discharged to the outside in a degassing process, and improving lifespan and storage characteristics of a battery by supplying an electrolyte corresponding to an amount of electrolyte decomposed and consumed in the case in which the electrolyte is consumed during repetitive charging and discharging of the battery module.

### Solution to Problem

In one general aspect, a battery module includes: an electrode assembly including a plurality of cathode plates, a plurality of anode plates, and a plurality of separators each interposed between the plurality of cathode plates and the plurality of anode plates; a pouch receiving the electrode assembly therein; and an electrode retaining structure received together with the electrode assembly in the pouch and having a space capable of retaining an electrolyte.

The electrode retaining structure may have the same thickness as that of the electrode assembly.

The electrode retaining structure may be positioned at a lower portion of the electrode assembly.

The electrode retaining structure may be positioned at a side of the electrode assembly.

The electrode retaining structure may be positioned at an upper portion of the electrode assembly and be positioned at a position at which it does not interfere with an anode tap and a cathode tap of the electrode assembly.

The electrode retaining structure may be manufactured in a lattice shape.

The electrode retaining structure may be manufactured in a pipe shape in which it has a plurality of holes perforated therein.

### Advantageous Effects of Invention

With the battery modules according to an exemplary embodiment of the present invention, the electrolyte retaining structure capable of retaining the electrolyte is inserted into the pouch, thereby making it possible to store an extra electrolyte in the battery module, prevent the electrolyte from being discharged to the outside in a degassing process, and improve lifespan and storage characteristics of a battery by supplying the electrolyte corresponding to an amount of electrolyte decomposed and consumed in the case in which the electrolyte is consumed during repetitive charging and discharging of the battery module.

### BRIEF DESCRIPTION OF DRAWINGS

The above and other objects, features and advantages of the present invention will become apparent from the following description of preferred embodiments given in conjunction with the accompanying drawings, in which:

FIG. 1 is an exploded view of a battery module according to an exemplary embodiment of the present invention.

FIG. 2 is a view showing a battery module according to a first exemplary embodiment of the present invention.

FIG. 3 is a view showing a battery module according to a second exemplary embodiment of the present invention.

FIG. 4 is a view showing a battery module according to a third exemplary embodiment of the present invention.

FIGS. 5A and 5B are, respectively, views showing an electrolyte retaining structure according to first and second exemplary embodiments of the present invention.

[Detailed Description of Main Elements]

100: battery module 110: electrode assembly
111: cathode tab 112: anode tab
120: pouch 130: electrolyte retaining structure
131: lattice type structure 132: pipe type structure

### BEST MODE FOR CARRYING OUT THE INVENTION

Hereinafter, a technical spirit of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

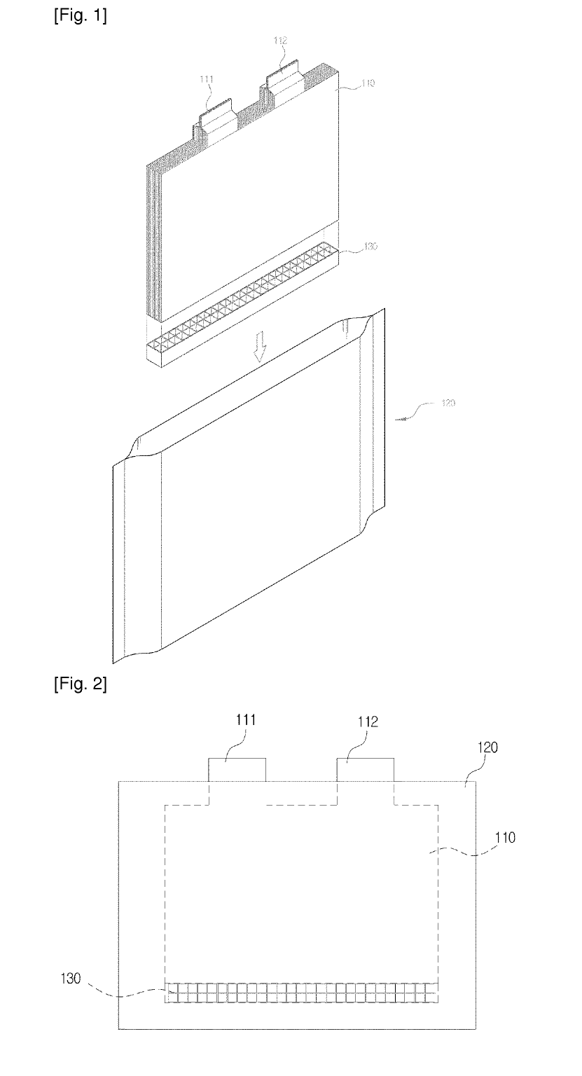

A structure and a shape of a battery module 100 according to an exemplary embodiment of the present invention will be described with reference to FIG. 1.

The battery module 100 is configured to include an electrode assembly 110, a pouch 120, and an electrolyte retaining structure 130.

The electrode assembly 110 includes battery cells each including a cathode plate, an anode plate, and a separator interposed between the cathode plate and the anode plate; and electrode tabs 111 and 112 bonded to each other so that the battery cells are electrically connected to each other.

More specifically, the electrode assembly 110 is configured to include the anode plate generally made of carbon, the cathode plate generally made of a lithium compound, and the separator preventing a contact between the cathode plate and the anode plate. In addition, an inner portion of the electrode assembly 110 is filled with an electrolyte.

Lithium ions in the electrolyte moves toward the anode plate at the time of charging and moves toward the cathode plate at the time of discharging, and each of the anode and cathode plates discharges or absorbs surplus electrons to generate a chemical reaction. The electrons flow to the electrode tabs 111 and 112 connected to external terminals in this process.

The electrode tabs 111 and 112 include an anode tab 112 and a cathode tab 111 and are bonded to portions extended from the cathode plate and the anode plate, respectively.

That is, the anode tab 112 is bonded to a portion extended from a plurality of anode plates and partially protrudes outwardly in the case in which the electrode assembly 110 is received in the pouch 120.

That is, the cathode tab 111 is bonded to a portion extended from a plurality of cathode plates and partially protrudes outwardly in the case in which the electrode assembly 110 is received in the pouch 120.

The electrode assembly 110 is not limited to having a structure in which the anode tab 112 and the cathode tab 111 are formed at an upper portion as shown in FIG. 1, but may also have a structure in which the anode tab 112 is formed at one side and the cathode tab 111 is formed at the other side.

The pouch 120 receives the electrode assembly 110 therein and seals the electrode assembly 110 in a state in which the anode tab 112 and the cathode tab 111 are exposed.

The electrolyte retaining structure 130 is received together with the electrode assembly 110 in the pouch 120.

In the case in which the pouch 120 receives the electrode assembly 110 in which both of the cathode tab 111 and the anode tab 112 are formed at one side, only one side of the pouch 120 is opened, such that the electrode assembly 110 is inserted into the pouch 120 through the opened side and then sealed.

Further, in the case in which the pouch 120 receives the electrode assembly 110 in which the cathode tab 111 and the anode tab 112 are formed at both sides, respectively, both sides of the pouch 120 are opened, such that the electrode assembly 110 is inserted into the pouch 120 through the opened sides and then sealed.

In addition, the pouch 120 has a structure in which a surface of a metal thin film is laminated with an insulating polymer.

The metal thin film has a structure for maintaining physical strength, prevents penetration of moisture, or the like, from the outside, and effectively radiates heat generated in the inside to the outside.

In addition, the metal thin film may be made of any one selected from a group consisting of an alloy of iron, carbon, chrome, and manganese, an alloy of iron, chrome, and nickel, aluminum, and an equivalent thereof. In the case in which the metal thin film is made of a material containing iron, strength of the metal thin film increases, and in the case in which the metal thin film is made of a material containing aluminum, flexibility of the metal thin film increases. Generally, it is preferable to use a metal thin film made of the aluminum material.

Meanwhile, the electrolyte retaining structure 130 has a space formed therein and capable of retaining the electrolyte and is partially opened so that the electrolyte may be injected thereinto.

In addition, it is preferable that the electrolyte retaining structure 130 is manufactured to have the same thickness as that of the electrode assembly 110, such that the electrolyte retaining structure 130 is formed to be flat without a portion protruding outwardly in the case in which it is received in the pouch 120 and then sealed.

Battery modules 100 according to several exemplary embodiments of the present invention will be described with reference to FIGS. 2 to 4.

In the case in which the electrode retaining structure 130 is received together with the electrode assembly 110 in the pouch 120, the electrode retaining structure 130 may be installed at any one or more of an upper portion, a side, and a lower portion of the electrode assembly 110.

As shown in FIG. 2, the electrolyte retaining structure 130 may be positioned at the lower portion of the electrode assembly 110.

In the case in which the electrolyte retaining structure 130 is positioned at the lower portion of the electrode assembly 110, the electrolyte is filled in the space formed in the electrolyte retaining structure 130, such that in the case in which charging and discharging are generated in the electrode assembly 110 to consume the electrolyte, thereby causing insufficiency of the electrolyte, the electrolyte filled in the electrolyte retaining structure 130 is supplied to the electrode assembly 110.

In this case, it is preferable that the electrolyte retaining structure 130 has an opened path in a surface thereof contacting the electrode assembly 110 so that the electrolyte may move, in order to smoothly supply the electrolyte to the electrode assembly 110.

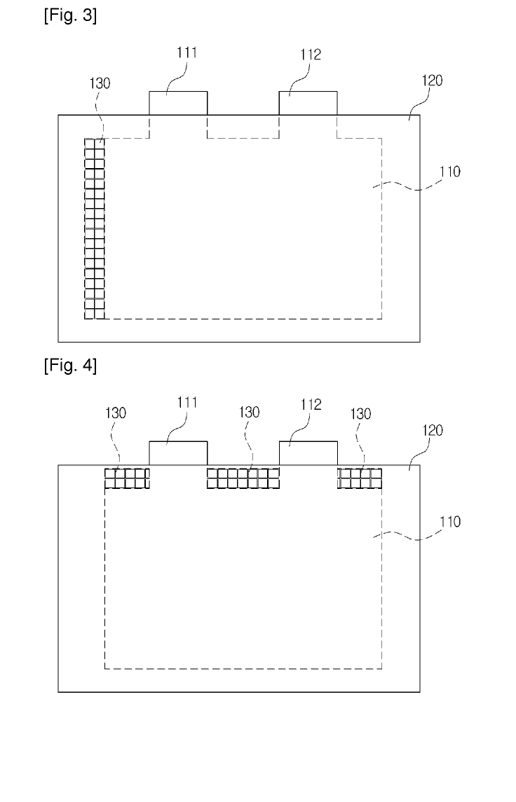

As shown in FIG. 3, the electrolyte retaining structure 130 may be positioned at the side of the electrode assembly 110.

In the case in which the electrolyte retaining structure 130 is positioned at the side of the electrode assembly 110, the electrolyte is filled in the space formed in the electrolyte retaining structure 130, such that in the case in which charging and discharging are generated in the electrode assembly 110 to consume the electrolyte, thereby causing insufficiency of the electrolyte, the electrolyte filled in the electrolyte retaining structure 130 is supplied to the electrode assembly 110.

In this case, it is preferable that the electrolyte retaining structure 130 has an opened path in a surface thereof contacting the electrode assembly 110 so that the electrolyte may move, in order to smoothly supply the electrolyte to the electrode assembly 110.

As shown in FIG. 4, the electrolyte retaining structure 130 may be positioned at the upper portion of the electrode assembly 110.

In the case in which the electrolyte retaining structure 130 is positioned at the upper portion of the electrode assembly 110, the electrolyte is filled in the space formed in the electrolyte retaining structure 130, such that in the case in which charging and discharging are generated in the electrode assembly 110 to consume the electrolyte, thereby causing insufficiency of the electrolyte, the electrolyte filled in the electrolyte retaining structure 130 is supplied to the electrode assembly 110.

In addition, since the cathode tab 111 and the anode tab 112 are positioned at the upper portion of the electrode assembly 110, it is preferable that the electrolyte retaining structure is positioned at a position at which it does not interfere with the cathode tab 111 and the anode tab 112.

That is, it is preferable that the electrolyte retaining structure 130 is positioned at one or more of an outer portion of the cathode tab 111, an outer portion of the anode tab 112, and a portion between the cathode tab 111 and the anode tab 112.

In this case, it is preferable that the electrolyte retaining structure 130 has an opened path in a surface thereof contacting the electrode assembly 110 so that the electrolyte may move, in order to smoothly supply the electrolyte to the electrode assembly 110.

Further, in the case in which the electrolyte retaining structure 130 is positioned at the upper portion of the electrode assembly 110, the electrolyte in the electrolyte retaining structure 130 may be supplied to the electrode assembly 110 by gravity.

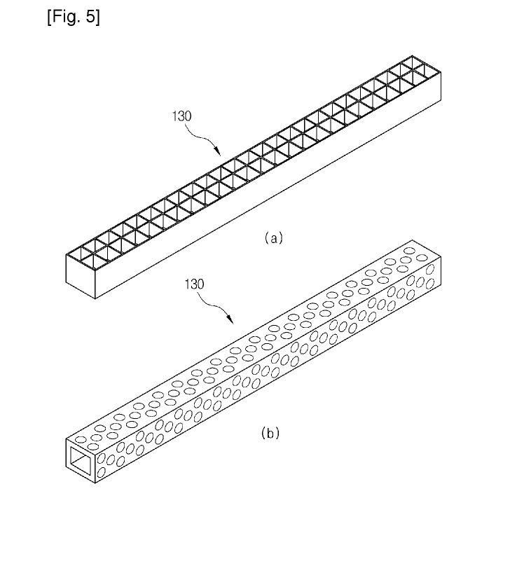

A shape of the electrolyte retaining structure 130 according to the exemplary embodiment of the present invention will be described with reference to FIGS. 5A and 5B.

The electrode retaining structure 130 may be manufactured as a lattice type structure 131 having a lattice shape. That is, the lattice type structure 131 is manufactured in a rectangular pillar shape and has an inner portion formed in a lattice shape, such that a space capable of retaining the electrolyte may be formed therein (See FIG. 5A).

In this case it is preferable that a surface of the lattice type structure 131 through which the electrolyte moves is positioned at a portion at which it contacts the electrode assembly 110, such that the electrolyte may be smoothly supplied to the electrode assembly 110.

The electrode retaining structure 130 may be manufactured as a pipe type structure 132 having a pipe shape. The pipe type structure 132 may be manufactured to have a plurality of holes perforated in an outer peripheral surface thereof, such that inner and outer portions thereof may be in communication with each other. That is, the pipe type structure 132 is manufactured in the pipe shape, such that the electrolyte may be retained therein, and has the plurality of holes perforated in then outer peripheral surface thereof to receive the electrolyte therein, thereby making it possible to supply the electrolyte to the electrode assembly 110 (See FIG. 5B).

Here, it is preferable that the electrolyte retaining structure 130 is disposed so that the electrolyte may be smoothly supplied to the electrode assembly 110 since the electrolyte retaining structure 130 has a number of holes formed in a surface through which the electrolyte moves.

Therefore, with the battery modules 100 according to the exemplary embodiment of the present invention, the electrolyte retaining structure 130 capable of retaining the electrolyte is inserted into the pouch, thereby making it possible to store an extra electrolyte in the battery module 100, prevent the electrolyte from being discharged to the outside in a degassing process, and improve lifespan and storage characteristics of a battery by supplying the electrolyte corresponding to an amount of electrolyte decomposed and consumed in the case in which the electrolyte is consumed during repetitive charging and discharging of the battery module 100.

1. A battery module comprising:
an electrode assembly including a plurality of cathode plates, a plurality of anode plates, and a plurality of separators each interposed between the plurality of cathode plates and the plurality of anode plates;
a pouch receiving the electrode assembly therein; and
an electrode retaining structure received together with the electrode assembly in the pouch and having a space capable of retaining an electrolyte.

2. The battery module of claim 1, wherein the electrode retaining structure has the same thickness as that of the electrode assembly.

3. The battery module of claim 1, wherein the electrode retaining structure is positioned at a lower portion of the electrode assembly.

4. The battery module of claim 1, wherein the electrode retaining structure is positioned at a side of the electrode assembly.

5. The battery module of claim 1, wherein the electrode retaining structure is positioned at an upper portion of the electrode assembly and is positioned at a position at which it does not interfere with an anode tap and a cathode tap of the electrode assembly.

6. The battery module of claim 1, wherein the electrode retaining structure is manufactured in a lattice shape.

7. The battery module of claim 1, wherein the electrode retaining structure is manufactured in a pipe shape in which it has a plurality of holes perforated therein.
